(19) United States
(12) Patent Application Publication
(10) Pub. No.: US 2012/0256749 A1
(43) Pub. Date: Oct. 11, 2012

(54) Method and Apparatus for Health Monitoring

(75) Inventors: Manoharprasad K. Rao, Novi, MI (US); Jialiang Le, Canton, MI (US); Kwaku O. Prakah-Asante, Commerce Township, MI (US); Krishnaswamy Venkatesh Prasad, Ann Arbor, MI (US)

(73) Assignee: FORD GLOBAL TECHNOLOGIES, LLC, Dearborn, MI (US)

(21) Appl. No.: 13/083,856

(22) Filed: Apr. 11, 2011

(51) Int. Cl. G08B 21/02; H04M 11/04; G06F 7/00

(52) U.S. Cl. 340/573.1; 701/1; 455/404.1

(57) ABSTRACT

A computer implemented method includes communicating with one or more medical and/or wellness devices. The method further includes receiving one or more data related to a medical or wellness condition from at least one of the one or more medical and/or wellness devices. The method additionally includes reporting a measurement from the one or more medical devices based at least in part on the received data.

### TECHNICAL FIELD

The illustrative embodiments generally relate to a method and apparatus for health monitoring and/or health monitoring feedback.

### BACKGROUND

The American population is aging and medical costs are soaring. According to the World Health Organization (WHO), the worldwide number of people age 50 and older was 650 million in 2006. The WHO expects this total to reach 1.2 billion by 2025. In the US, people who are 65 years old or older now constitute an increasing share of the population, a number that is expected to rise steadily in the future. Home-based health monitoring and wellness systems are projected to increase significantly in the next decade.

At the moment, there is a dramatic increase in the number of health monitoring devices on the market, as smaller, portable and less expensive technologies begin to replace larger, costlier equipment. These devices provide patients with a means to monitor health conditions, including, but not limited to, blood glucose, blood pressure, heart rate, temperature, pulse, respiration, skin conductance, dehydration and many other body conditions.

### SUMMARY

In a first illustrative embodiment, a computer implemented method, executable by a vehicle associated computing system, includes communicating with one or more medical and/or wellness devices. The illustrative method further includes receiving one or more data related to a medical or wellness condition from at least one of the one or more medical and/or wellness devices. The illustrative method additionally includes reporting a measurement from the one or more medical devices based at least in part on the received data.

In a second illustrative embodiment, a computer readable storage medium storing instructions that, when executed by a processor as part of a vehicle associated computing system, cause the vehicle associated computing system to perform the method including communicating with one or more medical and/or wellness devices. The system is also caused to receive one or more data related to a medical or wellness condition from at least one of the one or more medical and/or wellness devices. The system is further caused to report a measurement from the one or more medical devices based at least in part on the received data.

In yet another illustrative embodiment, a vehicle computing system includes at least one memory location, storing at least instructions executable by a vehicle processor for communication with a medical device. The system further includes at least one vehicle processor, in communication with the at least one memory location. The illustrative system also includes at least one output device, in communication with the processor and operable to output data from the processor. In this embodiment, the system further includes at least one medical device, in communication with at least the vehicle processor, wherein the system is operable to execute the instructions stored at the at least one memory location to communicate with the at least one medical device.

In this illustrative embodiment, the system is operable to receive data related to a medical or wellness condition from the at least one medical device. Also, the system is operable to report a measurement from the at least one medical device through the at least one output device based at least in part on the received data.

### BRIEF DESCRIPTION OF THE DRAWINGS

FIG. 1 shows an illustrative example of a vehicle computing system;

FIG. 2 shows an illustrative example of a process for monitoring one or more medical devices;

FIG. 3 shows an illustrative example of a process for vehicle startup control;

FIG. 4 shows an illustrative example of a system for monitoring portable devices;

FIG. 5 shows an illustrative example of a system for monitoring vehicle-mounted devices; and

FIG. 6 shows an illustrative example of a comprehensive system for medical device monitoring.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The illustrative embodiments present a vehicle based health monitoring and wellness solution by taking advantage of controls including, but not limited to, sensors, microcontroller units (MCUs), microprocessors, Digital Signal Processors ° (DSPs), analog front ends, memory devices, power Integrated Circuits (ICs), and transmitters and receivers which may already exist in a vehicle or which can be conveniently connected to the existing systems on a vehicle.

Assessing a driver physiological and emotional state is one potential use of an automotive based healthcare and wellness system. An integrated automotive biometric system allows inference of driver states including, but not limited to, cognitive, emotional, workload and fatigue, which may augment decision-making. Such monitoring may facilitate improved driver safety measures. The driver's state can be used, for example, as input to warn the driver and/or other vehicle occupants, and/or to send messages to appropriate health care professionals through, for example, wireless transmission. This data can be used to provide assistance to a driver if needed.

The illustrative embodiments may be used to target medical devices to provide driver health monitoring. In one example, the system utilizes portable home medical equipment, which patients may already own. This equipment may be carried with a patient while the patient is driving or riding in a vehicle. A monitored health state may be transmitted to an MCU through BLUETOOTH, ZigBee, or other appropriate protocol.

Warning thresholds may be pre-defined and stored in memory in the devices, or the thresholds may be stored in a local vehicle computing system or on a remote server. In one example, once a certain device's presence is detected, a vehicle computing system may be operable to download corresponding thresholds, which can be predetermined or even based on a specific patient setup.

The MCU may monitor the health state against preset thresholds. It may present a warning message to a driver via a vehicle computing system or other device, if a warning threshold is passed. The data can also be sent/uploaded to a remote source via a wireless connection to a remote server. Additionally or alternatively, in an extreme situation, for example, vehicle control may be co-opted by an automatic drive system and the vehicle may be safely guided to a roadside if a driver emergency occurs.

In a further illustrative embodiment, the system may monitor built-in non-intrusive health monitoring devices to monitor the driver's wellness state for safe driving. These devices may include, but are not limited to, heart rate monitors, temperature monitors, respiration monitors, etc. Such a health monitoring and wellness system may be used to warn drivers, wake drivers, or even prevent a vehicle from being started in the first place if a critical condition is present, for example.

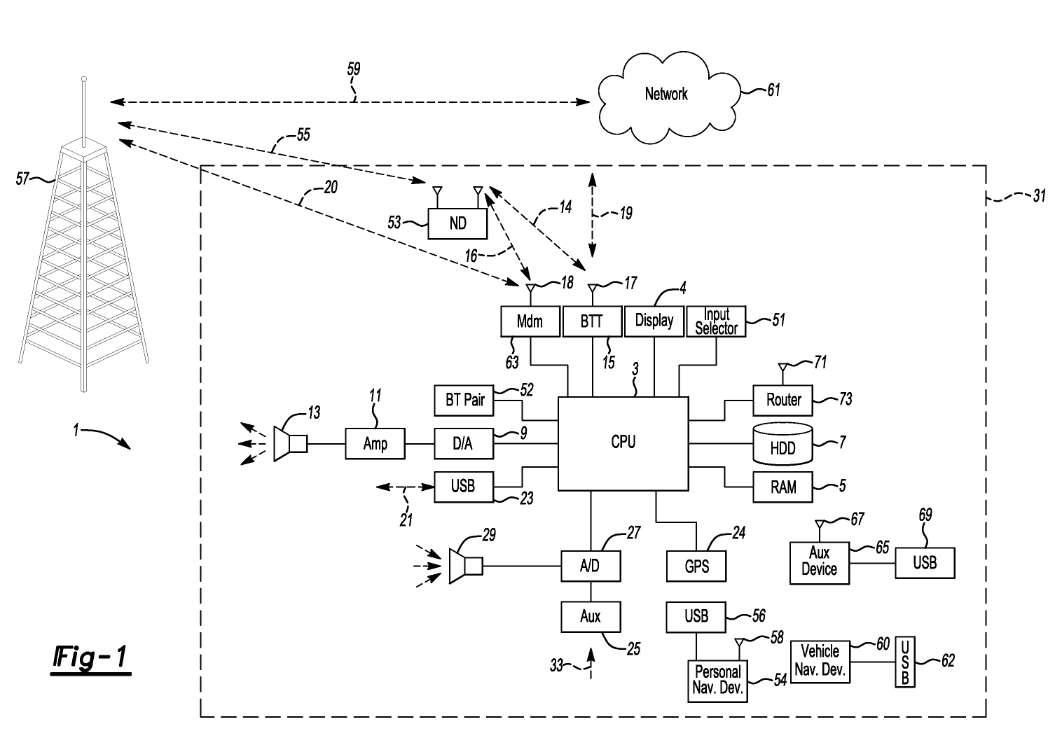

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an Application Program Interface (API) to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58; or a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73. Auxiliary device 65 may include, but are not limited to, personal media players, wireless health devices, portable computers, and the like.

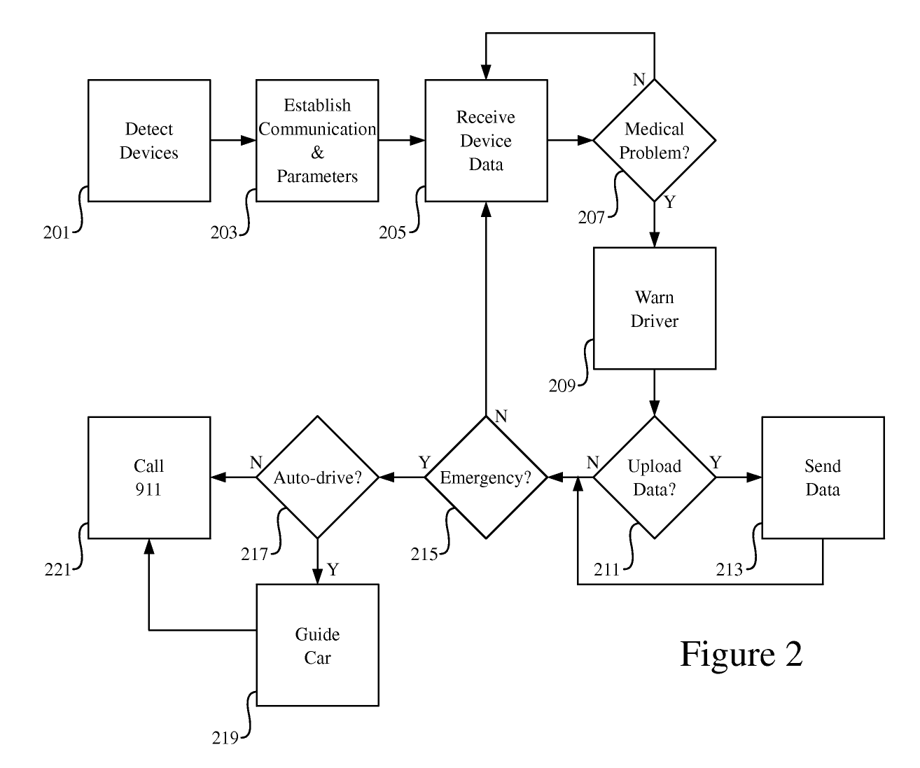

FIG. 2 shows an illustrative example of a process for monitoring one or more medical devices. In this illustrative example, a vehicle associated computing system executes a process that detects one or more medical devices 201. The devices could contact the system, or the system could poll for devices, determining if any devices to be monitored to be present.

If any devices are discovered, the process establishes communication with one or more of the discovered devices 203. For example, if a portable heart rate monitor is present in the vehicle, the process may discover the existence of the monitor and then communicate with the monitor. The communication process may also entail establishing one or more parameters. The parameters may relate to device protocols, threshold reading levels relating to emergencies, etc.

Once communication has been established with the desired medical devices, the process may then begin receiving data from the devices 205. Receipt of data can include, but is not limited to, continuous receipt of data, for use in, for example, logging data; periodic receipt of data; receipt of data for transmission; receipt of emergency data; etc.

As the data is received, the process checks to see if a medical problem exists 207. The existence of a medical problem may be determined by, for example, comparison of a reading from a device to a threshold measurement. The measurement may be previously established, downloaded or determined on a case-by-case basis, established based on patient parameters, etc. The comparison may be done in the vehicle associated computing system, at a remote server, in the medical device, etc.

If there is no medical problem, the process may continue to receive data until a problem is detected. Although not shown, the process may also log received data, transmit received data, or further process and use received data (such as, for example, reporting data back to the user as it is received). For example, if a blood pressure monitor were present, the process could periodically read blood pressure, log blood pressure readings for analysis, and report blood pressure readings back to the user. This is just one illustrative example of how the process could be used.

If there is a medical problem or the possibility of a medical problem, the process may warn the user 209. This warning could be visual, audible, and may be scaled in relation to the potential severity of the problem. For example, if blood pressure is a little high, the warning may be somewhat toned down, but if blood sugar drops to a dangerous level that might trigger shock, for example, then the process may provide a highly noticeable and immediate warning.

In addition to warning the user, the process may determine if medical device data should be uploaded to a remote location 211. Such a remote location can include, but is not limited to, a remote health data store, a medical provider, a medical monitoring service, etc. If there is a need to upload data, the process may use, for example, a wireless device in communication with a vehicle system to upload data to the remote destination 213.

If there is no need to upload data, or if the data has been uploaded, the process then checks to see if the measured condition equates to an emergency condition 215. For example, in one instance, a heart rate monitor may detect a slightly abnormal heart condition, and merely record the data for later analysis by a medical professional. In another instance, the heart rate monitor may determine that a heart attack has happened or appears to be imminent, and further emergency action may be taken.

In one illustrative example, the vehicle may be equipped with an auto-drive feature. This feature may be capable, for example, of guiding the vehicle to the side of a road, or at least of safely slowing a vehicle down so that an unconscious driver or otherwise incapacitated driver can have the vehicle safely stopped. In this illustrative example, the process checks to see if an auto-drive feature should be engaged, in order to, for example, safely park a vehicle.

If auto-drive is desired, the process may, for example, engage an automatic drive feature 219 that may take control of the vehicle. In another example, the auto-drive may give a user an “opt out” option, and, if no action is detected within a few seconds, the process may then take control of the vehicle. The action taken may also depend on a measured severity of a situation, for example.

Once the determination about auto-drive has been made, in this illustrative example, the process then may make a call to an emergency operator 221. This will alert an emergency operator of the emergency condition and help ensure that medical help is delivered to the vehicle occupant if needed.

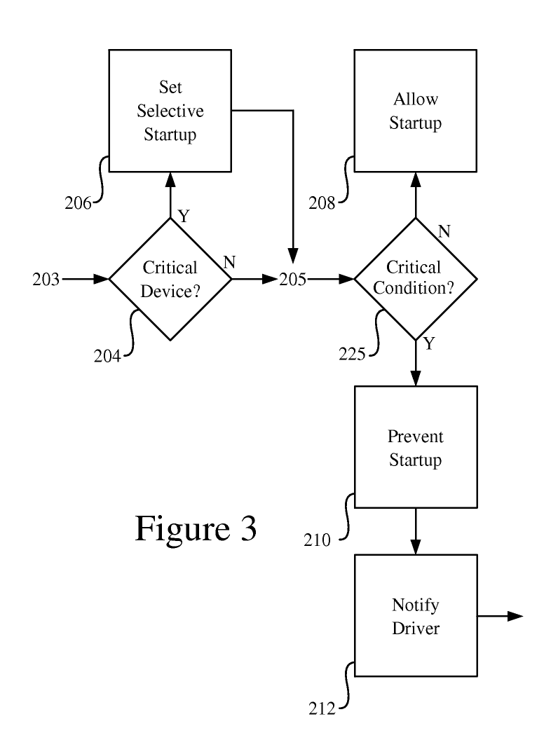

FIG. 3 shows an illustrative example of a process for vehicle startup control. In this illustrative example, the process may not permit a vehicle to be started if a certain medical condition exists. For example, if a potentially dangerous medical condition, such as a heart attack, an unconscious state, a state of shock, etc. may be likely to occur, the process may prevent the vehicle from being started. Of course, this prevention may also be over-ridable, in case the use of the vehicle is medically necessary, or in the event that more than one person is present, and the person with the medical emergency is merely a passenger.

In this example, the process may have already determined the presence of one or more medical devices. The process may have further established communication with those devices, and may have determined, activated, or downloaded thresholds for the device measurement levels as well. In this particular embodiment, the process determines if a “critical device” is present 204. In this example, a critical device is a device which is capable of detecting or sending data relating to an event likely to lead to loss of driver control. In another embodiment, the process may automatically enable selective startup, without detecting the presence of a critical device.

In this example, if a critical device is present, the process enables a selective startup feature 206. Selective startup, in this example, relates to allowing the vehicle to start only if a critical condition such as a critical medical condition is not present, or, put another way, preventing vehicle startup in the presence of a critical condition.

In this example, the process checks to see if a critical condition is present 225. If there is no critical condition present, vehicle startup is allowed 208. Even if selective startup is not enable mode, in this example, a nonexistent critical condition would result in startup, since the startup prevention would not be triggered.

If a critical condition is present, the process may prevent the vehicle from being started 210. In this illustrative example, the selective startup feature would also be in enable mode to have this event occur, but in another case selective startup may always be enabled. Additionally or alternatively, if startup is prevented, a user/driver may be given an option to manually disable the selective startup. This can allow driving of a vehicle in an emergency, even if a medical condition is present.

In addition to preventing startup, a notification may be presented to a driver that the vehicle cannot be started 212. The notification may additionally inform the driver as to the reason for the non-start, and may further give the option to contact an emergency care provider if a critical condition appears to be in the onset.

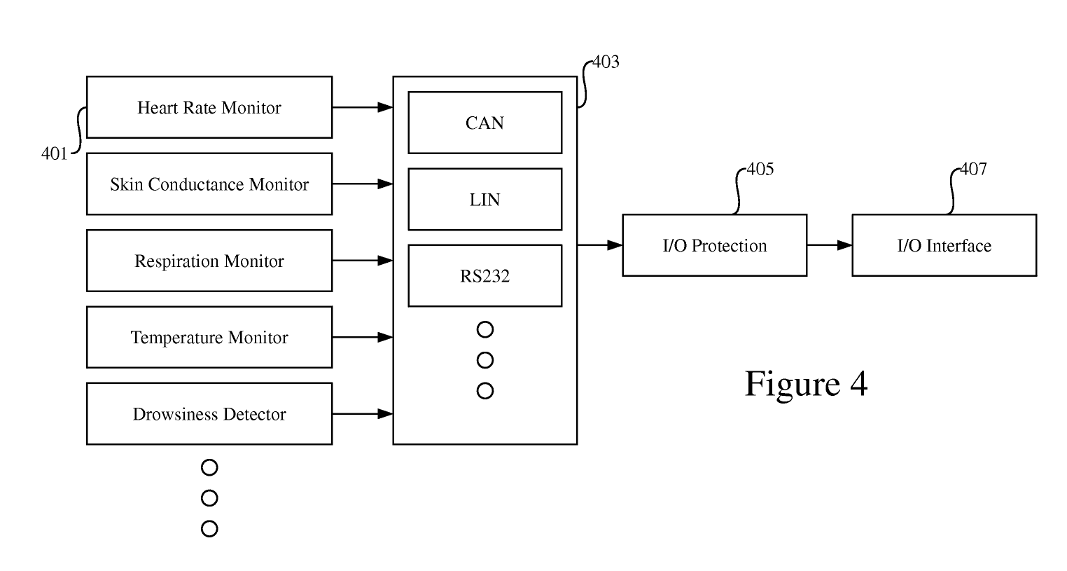

FIG. 4 shows an illustrative example of a system for monitoring built-in vehicle devices.

In one illustrative instance, the respiration monitor may be a monitor built into a safety restraint, such as a seat belt. When the seat belt is fastened, the monitor may be enabled. By measuring the movement of a person's chest cavity or diaphragm, for example, the belt may be able to monitor respiration and determine if a critical condition is occurring.

In another illustrative example, one or more heart rate monitors may be included with the vehicle. For example, the steering wheel may have one or more monitors included therewith, such that a user need only grasp the monitors to have a measurement of their heart rate taken.

The vehicle may further be equipped with a body temperature monitor. In this illustrative example, an infrared camera or other heat sensing device may be aimed at one or more portions of one or more vehicle occupants. By measuring and tracking the temperature of the one or more vehicle occupants, a vehicle system may be able to detect the onset of a sick or critical condition in a monitored occupant.

In this illustrative example, a system for monitoring medical devices is shown. This is a high-level schematic of an illustrative health and wellness monitoring system. This illustrative example shows the communication of one or more exemplary devices with a vehicle associated computing system MCU. Warnings from this system may be audibly or visually output, either through the vehicle, the device or both. Warning could also be output through a different device, if desired. In addition to having the capability of outputting warnings, a monitoring system may have the potential to send data through a wireless device, such as, but not limited to, a cellular phone, to a remote location. The MCU may also be capable of dialing emergency services, as needed, and may be operable to trigger an auto-drive system.

In this illustrative example, a plurality of medical devices may be present as built-in devices 401. These devices include, but are not limited to, heart rate monitors, skin conductance monitors, respiration monitors, temperature monitors, drowsiness detectors, etc.

The devices are capable of wired and/or wireless communication with vehicle networks 403. Vehicle networks include, but are not limited to, a CAN bus, an LIN bus, etc. In addition to receiving data from the devices, the vehicle associated computing system may employ one or more forms of input output protection 405. This can prevent unauthorized access and can prevent the propagation of improper or bad data. Once the protections, if desired, have been implemented, the system may provide an I/O interface 407 for interaction with the one or more medical devices or medical service providers.

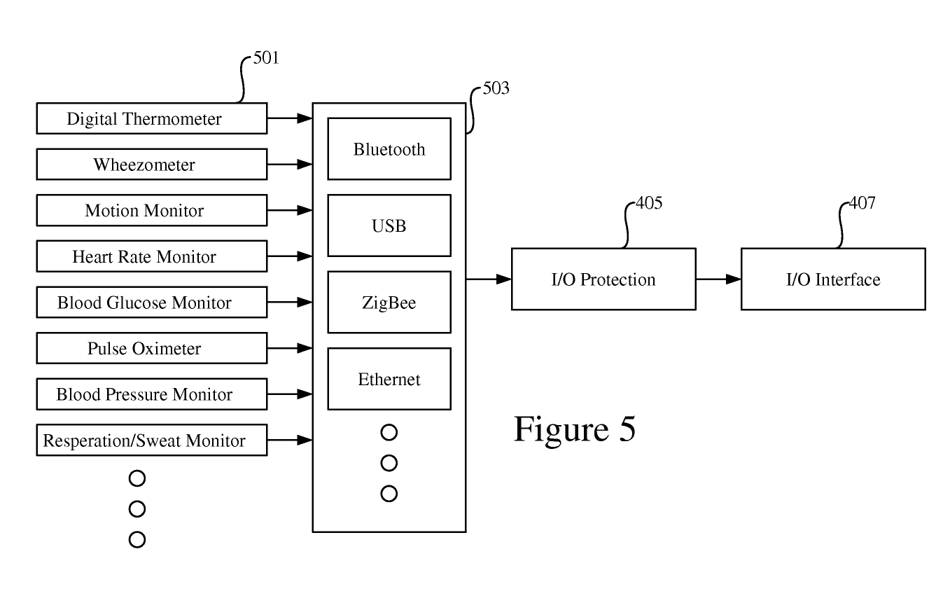

FIG. 5 shows an illustrative example of a system for monitoring portable medical devices. Similar to the system shown with respect to FIG. 4, the system of FIG. 5 provides interaction with portable medical devices 501.

In at least one illustrative example, one or more portable medical monitoring devices are present 501. These devices may include, but are not limited to, a digital thermometer, a wheezometer, a motion monitor, a blood glucose monitor, a pulse oximiter, a blood pressure monitor, a respiration/sweat monitor, etc. 501. These portable medical monitoring devices may be in communication with a vehicle associated computing system through, for example, a BLUETOOTH connection, a ZigBee connection, a USB connection, an Ethernet connection, etc. 503.

As with the vehicle mounted devices, the portable devices may have input/output protection 405 associated therewith, to prevent unauthorized access of a vehicle system. Once any desired I/O protection has been implemented, the devices may be accessible through an I/O interface 407.

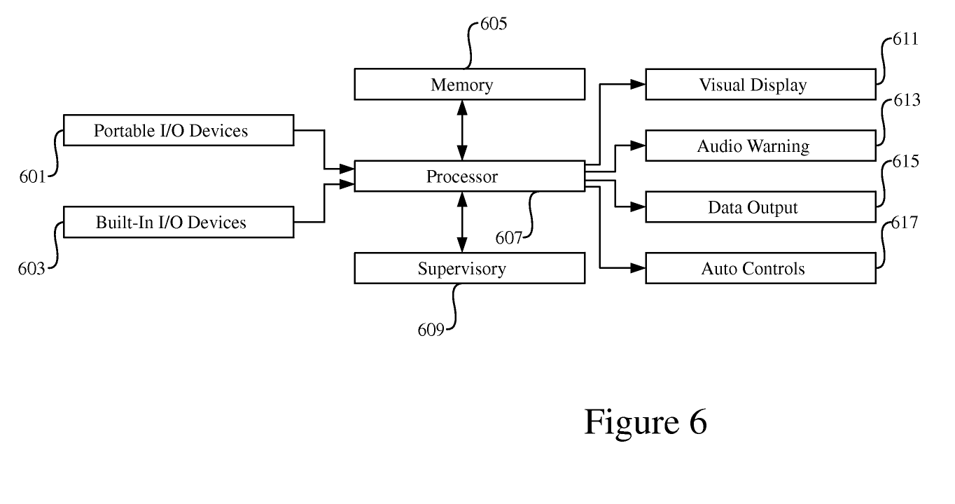

FIG. 6 shows an illustrative example of a comprehensive system for medical device monitoring. In this illustrative example, a system for monitoring both vehicle-mounted and portable medical devices is shown at a high level. Included in this exemplary system are both portable I/O medical/wellness devices 601 and vehicle-mounted medical devices 603. These devices can include, but are not limited to, devices such as those presented in the earlier examples.

In this illustrative system, the medical devices are in communication with at least a processor of a vehicle associated computing system 607. The communication may be wired or wireless, and it may further pass through one or more vehicle networks before reaching the processor. In other words, direct communication with the processor is not required. The processor may also be in communication with one or more vehicle memory devices or locations 605, and may further be operable to process one or more supervisory routines 609.

Additionally or alternatively, the processor may be in communication with a visual display such as, but not limited to, a vehicle navigation display, a radio display, or an instrument panel display 611. The system may be able to, for example, output warnings through such a display, or, in an alternative or additional example, the system may be able to output device readings through the display. If the display is a touch operable display, or has other control functions associated therewith, the vehicle occupant may further be able to control one or more medical devices through use of the controls.

The system may also have access to a vehicle audio system. The vehicle audio system may provide the capability for the system to output warnings or device readings to a vehicle occupant. Additionally or alternatively, voice-activated commands may be associated with the audio system and may be usable to control the medical device through the system.

The system may additionally have access to other data output means 615. These may include, but are not limited to, remote storage of data, remote relay of data, storage of data on a wireless device, such as a cellular phone, etc. Output of data to a remote source not directly in communication with a vehicle may be facilitated through a connection using a wireless device in communication with both the vehicle system and a remote source.

The vehicle system may further be in communication with one or more automatic vehicle controls. These controls may be capable of, for example, automatically controlling a vehicle in an emergency situation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method, executable by a vehicle associated computing system, comprising:
communicating with one or more medical and/or wellness devices;
receiving one or more data related to a medical or wellness condition from at least one of the one or more medical and/or wellness devices; and
reporting a measurement from the one or more medical devices based at least in part on the received data.

2. The method of claim 1, further comprising:
detecting the presence of one or more medical and/or wellness devices; and
initiating communication with at least one detected device.

3. The method of claim 1, wherein the medical and/or wellness devices include at least one wireless, portable device.

4. The method of claim 1, wherein the medical and/or wellness devices include at least one built-in vehicle device.

5. The method of claim 1, further comprising:
setting a measurement threshold for at least one medical device; and
determining if received data from the at least one medical device for which the threshold was set exceeds the set threshold.

6. The method of claim 1, further comprising:
determining if a critical medical condition exists, based at least in part on received data; and
taking at least one emergency action dependent on the determination that at least one critical condition exists.

7. The method of claim 6, wherein the emergency action further includes contacting an emergency 911 operator.

8. The method of claim 6, wherein the emergency action further includes activating an automatic drive function.

9. The method of claim 6, wherein the emergency action further includes alerting an occupant to the presence of the emergency condition.

10. A computer readable storage medium storing instructions that, when executed by a processor as part of a vehicle associated computing system, cause the vehicle associated computing system to perform the method comprising:
communicating with one or more medical and/or wellness devices;
receiving one or more data related to a medical or wellness condition from at least one of the one or more medical and/or wellness devices; and
reporting a measurement from the one or more medical devices based at least in part on the received data.

11. The computer readable storage medium of claim 10, wherein the method further comprises:
setting a measurement threshold for at least one medical device; and
determining if received data from the at least one medical device for which the threshold was set exceeds the set threshold.

12. The computer readable storage medium of claim 10, wherein the method further comprises:
determining if a critical medical condition exists, based at least in part on received data; and
taking at least one emergency action dependent on the determination that at least one critical condition exists.

13. The computer readable storage medium of claim 12, wherein the emergency action further includes contacting an emergency 911 operator.

14. The computer readable storage medium of claim 12, wherein the emergency action further includes activating an automatic drive function.

15. The computer readable storage medium of claim 12, wherein the emergency action further includes alerting an occupant to the presence of the emergency condition.

16. A vehicle computing system comprising:
at least one memory location, storing at least instructions executable by a vehicle processor for communication with a medical device;
at least one vehicle processor, in communication with the at least one memory location;
at least one output device, in communication with the processor and operable to output data from the processor; and
at least one medical device, in communication with at least the vehicle processor, wherein the system is operable to execute the instructions stored at the at least one memory location to communicate with the at least one medical device, wherein the system is further operable to receive data related to a medical or wellness condition from the at least one medical device, and wherein
the system is further operable to report a measurement from the at least one medical device through the at least one output device based at least in part on the received data.

17. The system of claim 16, wherein the system is further operable to set a measurement threshold for at least one medical device; and
wherein the system is operable to determine if received data from the at least one medical device for which the threshold was set exceeds the set threshold.

18. The system of claim 16, wherein the system is further operable to determine if a critical medical condition exists, based at least in part on received data; and wherein the system is operable to take at least one emergency action dependent on the determination that at least one critical condition exists.

19. The system of claim 18, wherein the emergency action further includes contacting an emergency 911 operator.

20. The system of claim 18, wherein the emergency action further includes activating an automatic drive function.
